(19) United States
(12) Patent Application Publication
(10) Pub. No.: US 2002/0030345 A1
(43) Pub. Date: Mar. 14, 2002

(54) Bicycle upper rear fork unit with high resistance to flexural and torsional stresses

(75) Inventor: Ernesto Colnago, Cambiago (IT)

Correspondence Address: STEINBERG & RASKIN, P.C., 1140 AVENUE OF THE AMERICAS, 15th FLOOR, NEW YORK, NY, 10036-5803, US

(73) Assignee: COLNAGO ERNESTO E C. S.R.L.

(21) Appl. No.: 09/950,486

(22) Filed: Sep. 10, 2001

(30) Foreign Application Priority Data
Sep. 8, 2000 (IT) MI2000U 000506

(51) Int. Cl. B62K 19/00

(52) U.S. Cl. 280/288

(57) ABSTRACT

A bicycle upper rear fork unit (1) comprises a one-piece body (10) and presents a fork (13) connected to a lower rear fork unit (4) of the bicycle, the upper fork unit (1) having a tubular end portion (12) arranged to cooperate with a saddle connection element (5) connecting the fork unit (1) to the remaining portion of the bicycle frame (2), the one-piece body (10) presenting a substantially triangular portion (15) interposed between the tubular portion (12) and the arms (14) of the fork (13). The saddle connection element (5) receives within one of its parts the tubular end portion (12) of the upper rear fork unit (1), said terminal portion (12) projecting from the said part of the saddle connection element (5) for a maximum distance of 2 centimeters measured from that vertex (17) of the triangular portion (15) close to the tubular portion to ensure a high resistance to rear flexural and torsional stresses.

The present invention relates to an upper rear fork unit for a bicycle in accordance with the introduction to the main claim.

A bicycle frame is known to comprise a lower and an upper rear fork unit which are joined together. The upper fork unit is connected to a saddle connection element.

Various upper rear fork units for bicycles are known. A known type of such fork units comprises a fork defined by tubular arms connected to the saddle connection element and joined together by a transverse stiffening element or bridge. This type of rear fork unit necessitates the assembly of several components, which is complicated and costly; moreover as the rear fork unit has much smaller cross-sections than the remaining part of the frame, said type of fork unit does not offer high resistance to flexural or torsional stresses, so negatively affecting the effective transfer of the power generated by the cyclist on the bicycle pedals. Other types of bicycle rear fork units are known; however these always present a limited resistance to flexural and torsional stresses, again limiting the effectiveness of the cyclist's action on the pedals and hence the cyclist's performance.

An object of the present invention is to offer an upper rear fork unit of a bicycle frame which improves force distribution on all parts of the frame, so allowing more effective use of the power exerted by the cyclist on the pedals.

A further object is to offer a rear fork unit of the stated type which is very light in weight while having high resistance to flexural and torsional stresses, so enabling optimum utilization of the force exerted by the cyclist on the pedals.

These and further objects which will be apparent to the expert of the art are attained by a bicycle rear fork unit in accordance with the accompanying claims.

The present invention will be more apparent from the accompanying drawing, which is provided by way of non-limiting example, and in which:

FIG. 1 is a side view of a bicycle frame provided with an upper rear fork according to the invention;

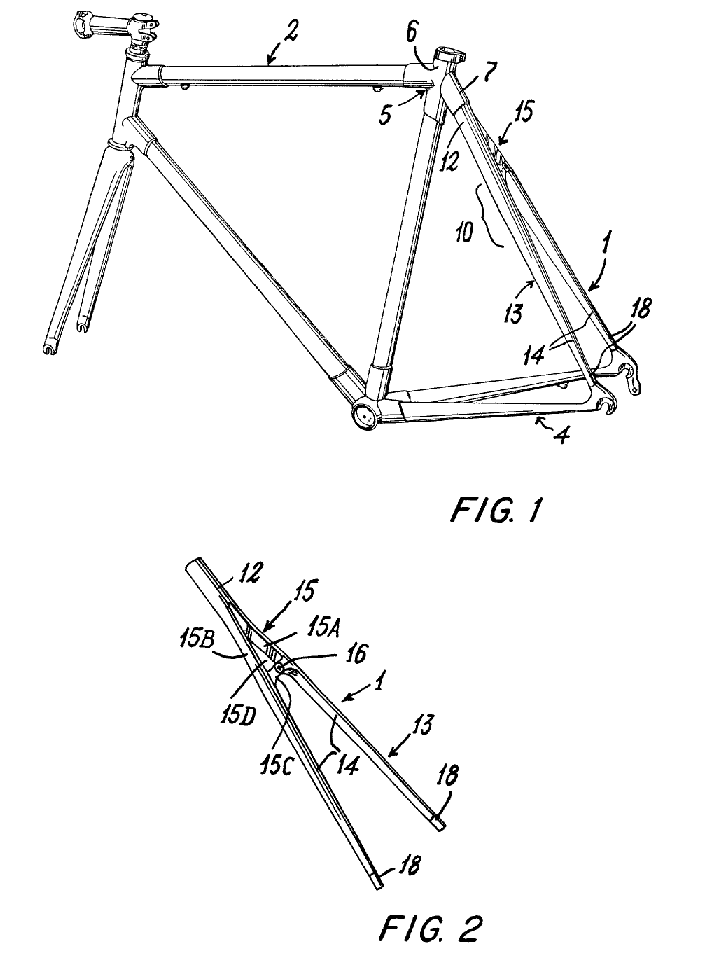

FIG. 2 is a perspective view of the rear fork unit of the invention;

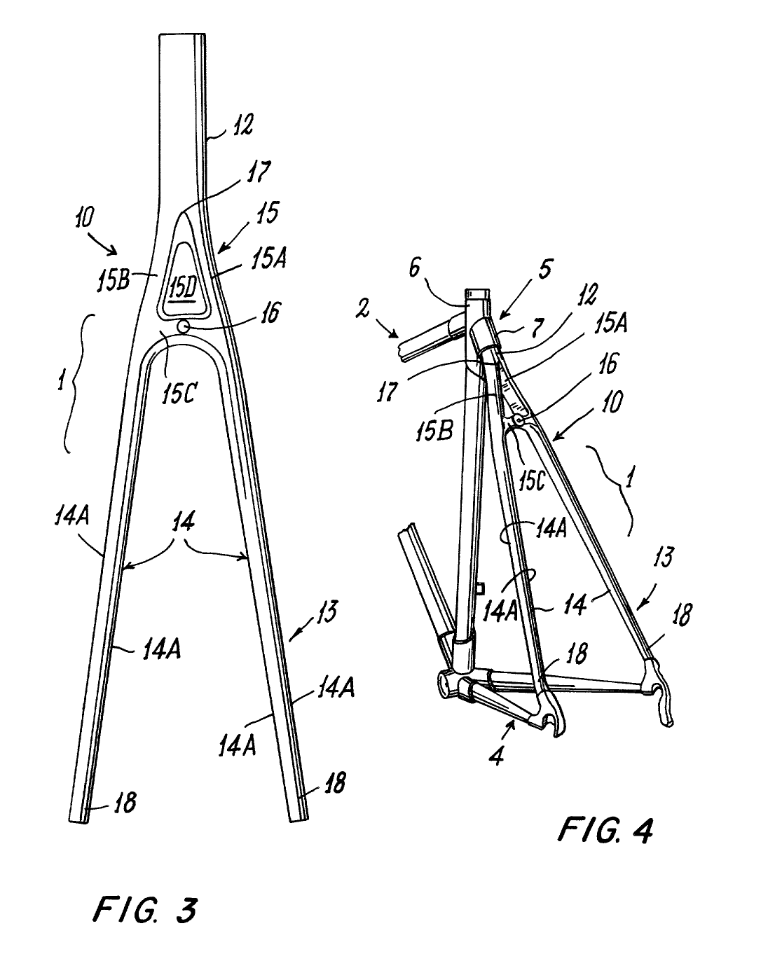

FIG. 3 is a front view of the rear fork unit of FIG. 2; and

FIG. 4 is a perspective view of the rear part of the frame of FIG. 1.

With reference to said figures, these show an upper rear fork unit 1 of a bicycle presenting a frame 2, of which this fork unit forms a part.

It is connected to a lower rear fork unit 4 and to a saddle connection element 5 presenting a core 6 and provided with a tubular part 7 connected to the fork unit 1.

The upper rear fork unit 1 comprises a one-piece body 10, preferably and advantageously constructed of composite material (such as carbon fibre) of very light weight and considerable resistance to mechanical stress.

The body 10 comprises a cylindrical end portion 12 of circular cross-section and a fork 13 presenting arms 14. Between these latter and the portion 12 there is a part 15 of substantially triangular shape presenting sides 15A, 15B, 15C, and a central cavity 15D. In the side 15C there is provided a seat 16 for fixing a usual brake member for the bicycle rear wheel, not shown.

The end portion 12 penetrates into the tubular part 7 of the saddle connection element 5, to which it is fixed in any known manner. The part 7 at least partly covers the portion 12; in particular, said part can reach as far as that vertex 17 of the triangular part 15 facing the portion 12 of the body 10 or be spaced from said vertex by up to a maximum of two centimeters, but preferably and advantageously by up to one centimeter.

Each arm 14 of the fork 13 has a variable cross-section: at that end 18 in proximity to the hub of the bicycle rear wheel (not shown), said arm is of circular cross-section, whereas in the remaining part it is of elliptical cross-section. Each arm also has a substantially conical shape tapering towards the end 18. Finally, the width of the opposing sides 14A of each arm 14 is greater than the transverse thickness of this arm; this is a consequence of the elliptical cross-section of said arm. Each arm hence has a greater cross-section in proximity to the part 15.

By virtue of the particular shape of the aforedescribed bicycle rear fork unit 1 and the particular manner in which it is coupled to the saddle connection element 6, this fork unit presents a high resistance to rear flexural and torsional stresses. As a consequence, it enables the cyclist to best utilize the power transferred to the pedals as the force generated on these latter is distributed uniformly over the entire frame and does not result in particular flexure and/or twisting of the upper rear fork unit.

1. A bicycle upper rear fork unit comprising a one-piece body (10) and presenting a fork (13) connected to a lower rear fork unit (4) of the bicycle, the upper fork unit (1) having a tubular end portion (12) arranged to cooperate with a saddle connection element (5) connecting the fork unit (1) to the remaining portion of the bicycle frame (2), the one-piece body (10) presenting a substantially triangular portion (15) interposed between the tubular portion (12) and the arms (14) of the fork (13), said tubular portion (12) being at least partly inserted into a part (7) of the saddle connection element (5), said part (7) being positioned on the tubular portion such as to reach a position between that in which it terminates at that vertex (17) of the triangular portion (15) facing said tubular portion and that in which said part (7) of the saddle connection element (5) terminates two centimeters from said vertex (17).

2. A rear fork unit as claimed in claim 1, characterised in that each arm (14) of the fork (13) lies between the triangular portion (15) and the hub of the bicycle rear wheel.

3. A rear fork unit as claimed in claim 2, characterised in that each arm (14) of the fork (13) tapers towards a free end (18) close to the hub of the bicycle rear wheel.

4. A rear fork unit as claimed in claim 3, characterised in that each arm (14) presents a circular cross-section at the free end (18) and an elliptical cross-section in its remaining part, said arm having its greatest cross-section in proximity to the triangular portion (15).

5. A rear fork unit as claimed in claim 1, characterised in that one side (15C) of the triangular portion (15) is positioned transversely to the fork (13) and presents a seat (16) for a bicycle rear brake.
